(19) United States
(12) Patent Application Publication
(10) Pub. No.: US 2016/0275529 A1
(43) Pub. Date: Sep. 22, 2016

(54) METHOD AND SYSTEM FOR RECOMMENDING A COMPETITOR

(71) Applicant: MasterCard Asia/Pacific Pte Ltd, Singapore (SG)

(72) Inventors: Suneel BHATT, Delhi (IN); Amit SINGH, Lucknow (IN); Hitendra GEHLOT, Ghaziabad (IN)

(21) Appl. No.: 15/074,921

(22) Filed: Mar. 18, 2016

(30) Foreign Application Priority Data
Mar. 20, 2015 (SG) 10201502188P

(51) Int. Cl. G06Q 30/02

(52) U.S. Cl. CPC G06Q 30/0201

(57) ABSTRACT

A system for recommending a competitor. A transactions database stores transaction data relating to a plurality of transactions made at a plurality of merchants over a payment network using a plurality of payment cards. A merchant database stores merchant data relating to the plurality of merchants. A competitor identification component in communication with the transactions database. The competitor identification component is configured to: determine a category of the merchant; query the merchant database to identify other merchants having the same category as the merchant; query the transactions database to retrieve transaction data relating to transactions made at the merchant and the other merchants over a predefined time period; based on one or more filtering criteria, determine similarity data indicative of a similarity of each of the other merchants to said merchant. Based on the similarity data, generate a recommendation of at least one competitor merchant from among the other merchants.

### RELATED APPLICATION

This application claims priority to Singapore Application No. 10201502188P, entitled METHOD AND SYSTEM FOR RECOMMENDING A COMPETITOR, filed Mar. 20, 2015 and is hereby incorporated by reference in its entirety.

### BACKGROUND

The present disclosure relates to methods and systems for determining a recommendation of one or more competitors of a merchant.

A key consideration for any merchant offering goods or services is to understand who his or her competitors are. This is quite often difficult to determine, because in most cases, merchants do not have access to financial data regarding customer spend at other merchants in the same industry, or to customer spend in the industry as a whole. Factors such as geographic proximity are also not always useful, since two merchants in the same industry which are nearby each other may not necessarily be competitors. For example, a mid-tier restaurant and a fine dining restaurant which are near each other would most likely not be competitors despite being in the same industry.

It would be desirable to provide a method and system which can address the above difficulties.

### SUMMARY

A system for recommending a competitor to a merchant comprises: a transactions database storing transaction data relating to a plurality of transactions made at a plurality of merchants over a payment network using a plurality of payment cards; a merchant database storing merchant data relating to the plurality of merchants; and a competitor identification component in communication with the transactions database; wherein the competitor identification component is configured to: determine a category of the merchant; query the merchant database to identify other merchants having the same category as the merchant; query the transactions database to retrieve transaction data relating to transactions made at the merchant and the other merchants over a predefined time period; based on one or more filtering criteria, determine similarity data indicative of a similarity of each of the other merchants to said merchant; and based on the similarity data, generate a recommendation of at least one competitor merchant from among the other merchants.

A method for recommending a competitor to a merchant comprises: storing, in a transactions database, transaction data relating to a plurality of transactions made at a plurality of merchants over a payment network using a plurality of payment cards; storing, in a merchant database, merchant data relating to the plurality of merchants; providing a competitor identification component in communication with the transactions database; determining, by the competitor identification component, a category of the merchant; querying, by the competitor identification component, the merchant database to identify other merchants having the same category as the merchant; querying, by the competitor identification component, the transactions database to retrieve transaction data relating to transactions made at the merchant and the other merchants over a predefined time period; determining, by the competitor identification component based on one or more filtering criteria, similarity data indicative of a similarity of each of the other merchants to said merchant; and generating, by the competitor identification component based on the similarity data, a recommendation of at least one competitor merchant from among the other merchants.

A non-transitory computer-readable medium for recommending a competitor to a merchant has stored thereon program instructions for causing at least one processor to: store, in a transactions database, transaction data relating to a plurality of transactions made at a plurality of merchants over a payment network using a plurality of payment cards; store, in a merchant database, merchant data relating to the plurality of merchants; determine a category of the merchant; query the merchant database to identify other merchants having the same category as the merchant; query the transactions database to retrieve transaction data relating to transactions made at the merchant and the other merchants over a predefined time period; determine, based on one or more filtering criteria, similarity data indicative of a similarity of each of the other merchants to said merchant; and generate, based on the similarity data, a recommendation of at least one competitor merchant from among the other merchants.

### BRIEF DESCRIPTION OF THE DRAWINGS

Embodiments of the invention will now be described, by way of non-limiting example only, with reference to the accompanying drawings in which:

FIG. 1 is a block diagram of a competitor recommender system in communication with a payment network and a user device;

FIG. 2 is a block diagram of a user device of FIG. 1;

FIG. 3 is a block diagram of the competitor recommender system of FIG. 1;

FIG. 4 is a flow diagram of a competitor recommender process; and

FIG. 5 is a flow diagram of a market segment analysis process.

### DETAILED DESCRIPTION OF EMBODIMENTS

Embodiments of the present invention relate to methods and systems for recommending a competitor based on transaction data received from a payment network. In general terms, transaction data corresponding to a plurality of transactions made over the payment network, by a plurality of payment cards, at a plurality of merchants, is retrieved from a transactions database and is used to determine a similarity score between a particular merchant and other merchants of the same category which satisfy one or more additional selection criteria, such as geographical proximity. A user at a user device (such as a mobile computing device or desktop computing device) may input details of a merchant for which one or more recommendations of potential competitors is to be generated. The user may be the merchant, who is registered with the competitor recommendation system, for example. The competitor recommendation system computes the similarity scores and outputs one or more potential competitor merchants which have the highest similarity scores (e.g., the top 5 similarity scores).

As used herein, the term “database” may refer to a body of data, a relational database management system (RDBMS), or both. A database may include any collection of data including hierarchical databases, relational databases, flat file databases, object-relational databases, object oriented databases, and any other structured collection of records or data that is stored in a computer system. The above examples are for illustration only, and are not intended to limit in any way the definition and/or meaning of the term database.

As used herein, the terms “transaction card,” “financial transaction card,” and “payment card” refer to any suitable cashless payment device, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC-enabled devices, and/or computers. Each type of transaction card can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

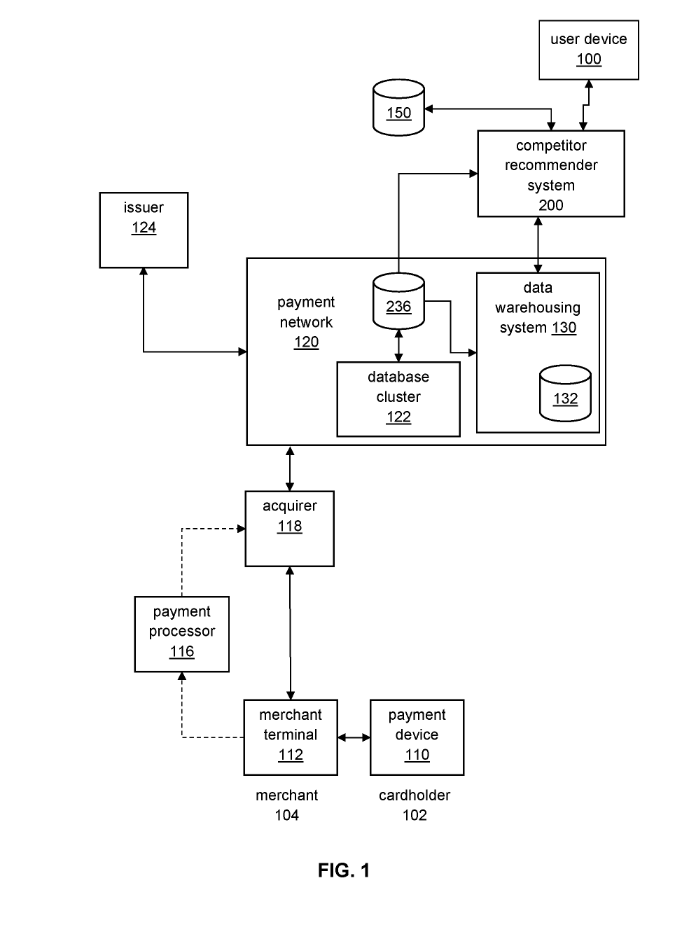

As shown in FIG. 1, a competitor recommendation system 200 receives transaction data from a payment network 120, such as the payment networks operated by MasterCard or VISA. The competitor recommendation system 200 is also in communication with a merchant database 150, in which are stored merchant records. Each merchant record may comprise a plurality of fields, such as a merchant doing business as (DBA) short name, a merchant location, and a merchant category code (MCC).

A user at user device 100 may send requests to, and receive output data from, the competitor recommendation system 200, for example via a web browser and/or a client application which interacts with a server application executing on competitor recommendation system 200, as will later be described.

The payment network 120 acts as an intermediary during a transaction being made by a cardholder 102 using a payment device 110 at a merchant terminal 112 of a merchant 104. In particular, the cardholder 102 may present payment device 110 to merchant terminal 112 of merchant 104 as payment for goods or services. The merchant terminal 112 may be a point of sale (POS) device such as a magnetic strip reader, chip reader or contactless payment terminal, or a website having online e-commerce capabilities, for example. A merchant 104 may operate one or a plurality of merchant terminals 112. The merchant terminal 112 communicates with an acquirer computer system 118 of a bank or other institution with which the merchant 104 has an established account, in order to request authorisation for the amount of the transaction (sometimes referred to as ticket size) from the acquirer system 118. In some embodiments, if the merchant 104 does not have an account with the acquirer 118, the merchant terminal 112 can be configured to communicate with a third-party payment processor 116 which is authorised by acquirer 118 to perform transaction processing on its behalf, and which does have an account with the acquirer entity.

The acquirer system 118 routes the transaction authorisation request from the merchant terminal 112 to computer systems of the payment network 120. The transaction authorisation request is then routed by payment network 120 to computer systems of the appropriate issuer institution (e.g., issuer 124 or 125) based on information contained in the transaction authorisation request. The issuer institution 124 or 125 is authorised by payment network 120 to issue payment devices 110 on behalf of customers 102 to perform transactions over the payment network 120. Issuer 124 or 125 also provides funding of the transaction to the payment network 120 for transactions that are approved.

The computer systems of issuer 124 or 125 analyse the authorisation request to determine the account number submitted by the payment device 110, and based on the account number, determine whether the account is in good standing and whether the transaction amount is covered by the cardholder's account balance or available credit. Based on this, the transaction can be approved or declined, and an authorisation response message transmitted from issuer 124 or 125 to the payment network 120, which then routes the authorisation response message to the acquirer system 118. Acquirer system 118, in turn, sends the authorisation response message to merchant terminal 112. If the authorisation response message indicates that the transaction is approved, then the account of the merchant 104 (or of the payment processor 116 if appropriate) is credited by the amount of the transaction.

During each authorisation request as described in the previous paragraphs, the payment network 120 stores transaction information in a transactions database 236 accessible via a database cluster 122. The database cluster 122 may comprise one or more physical servers. In some embodiments, the transactions database 236 may be distributed over multiple devices which are in communication with one another over a communications network such as a local-area or wide-area network. In some embodiments, the transactions database 236 may be in communication with a data warehousing system 130 comprising a data warehouse database 132 which may store copies of the transaction data, and/or cleaned and/or aggregated data which are transformed versions of the transaction data.

The data warehouse database 132 may also comprise records relating to individual cardholders, which, for example, may associate demographic information such as age, gender, number of dependents and salary range with a card identifier (e.g., a PAN), thereby permitting transaction data to be matched to demographic data. In some embodiments, each transaction record stored in the data warehouse database 132 may already have the matched demographic data stored as part thereof.

Transaction records (or aggregated data derived therefrom) may be directly accessible for the purposes of performing analyses, for example by payment device association system 200, from transactions database 236. Alternatively, or in addition, the transaction records (or aggregated data derived therefrom) may be accessed (for example, by payment device association system 200) from the data warehouse database 132. Accessing the transaction records from the data warehouse database 132, instead of the transactions database 236, has the advantage that the load on the transactions database 236 is reduced.

The transaction records may comprise a plurality of fields, including acquirer identifier/card accepter identifier (the combination of which uniquely defines the merchant); merchant category code (also known as card acceptor business code), that is, an indication of the type of business the merchant is involved in (for example, a gas station); cardholder base currency (i.e., U.S. Dollars, Euros, Yen, etc.); the transaction environment or method being used to conduct the transaction; product specific data such as SKU line item data; the transaction type; card identifier (e.g., card number); time and date; location (full address and/or GPS data); transaction amount (also referred to herein as ticket size); terminal identifier (e.g., merchant terminal identifier or ATM identifier); and response code (also referred to herein as authorization code). Other fields may be present in each transaction record.

Each terminal identifier may be associated with a merchant 104, for example in a merchant database (not shown) of the payment network 120. Typically, a particular merchant 104 will have a plurality of merchant terminal identifiers, corresponding to merchant terminals 112, associated with it.

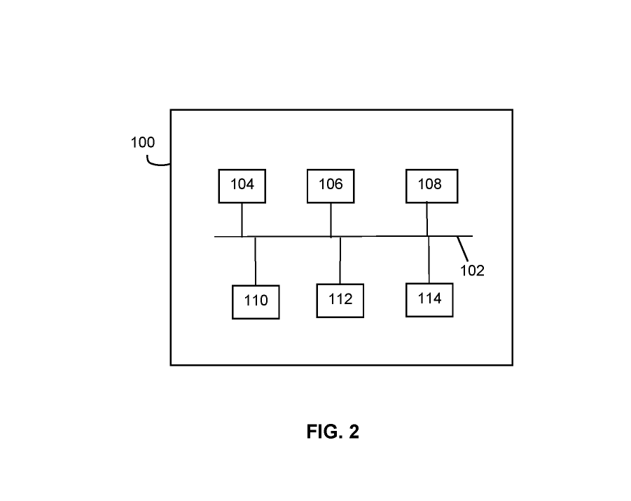

FIG. 2 illustrates a schematic view of an exemplary user device 100. The user device 100 may be, for example, a mobile phone, a tablet, a laptop, a personal computer, or a personal digital assistant (“PDA”). The user device 100 is arranged to receive information from and output information to a user of the user device 100. The user device 100 comprises a central processing unit (“CPU”) or “processing module” 104, a touch screen 106, a memory 108 for storing data, a network interface 110, input devices such as a camera 112 and a microphone 114, and output devices such as speakers 116, all interconnected by a bus 102. The touch screen 106, memory 108, network interface 110, camera 112, microphone 114 and speakers 116 may be integrated into the user device 100 as shown in FIG. 2. In alternative user devices one or more of the touch screen 106, memory 108, network interface 110, camera 112, microphone 114 and speakers 116 may not be integrated into the user device 100 and may be connected to the CPU 104 via respective interfaces. One example of such an interface is a USB interface.

User device 100 interacts with recommendation system 200 via processes executed by the user device 100 which are implemented in the form of programming instructions of one or more software modules or components stored on memory 108 associated with the user device 100. The software modules or components may comprise a web browser component and/or a special purpose software application for receiving input from the user, transmitting it to competitor recommender system 200, and receiving the results of processing from competitor recommender system 200 and displaying them to the user on display 106. User device 100 may also have stored, on memory 108, a number of standard modules such as an operating system (e.g., iOS or Android).

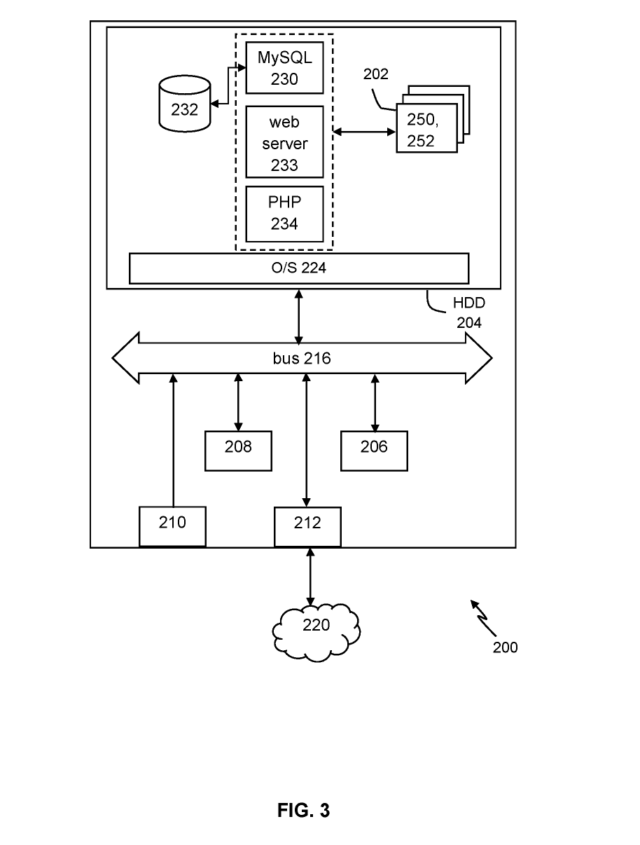

FIG. 3 illustrates an example of a competitor recommender system 200. In the described embodiment, the competitor recommender system is a standard computer system such as an Intel IA-32 based computer system 200, as shown in FIG. 3, and the associated processes executed by the system 200 are implemented in the form of programming instructions of one or more software modules or components 202, such as a recommender component 250 and a segmentation component 252, stored on tangible and non-volatile (e.g., solid-state or hard disk) storage 204 associated with the computer system 200, as shown in FIG. 3. However, it will be apparent that the processes could alternatively be implemented, either in part or in their entirety, in the form of one or more dedicated hardware components, such as application-specific integrated circuits (ASICs), and/or in the form of configuration data for configurable hardware components such as field programmable gate arrays (FPGAs), for example.

As will be described in more detail later, recommender component 250 retrieves transaction records from the transactions database 236 (or the data warehouse database 132), and analyses the transaction records to determine similarity scores between a particular merchant and a plurality of other merchants.

As shown in FIG. 3, the system 200 includes standard computer components, including random access memory (RAM) 206, at least one processor 208, and external interfaces 210, 212, all interconnected by a bus 216. The external interfaces may include universal serial bus (USB) interfaces 210, for example, and a network interface connector (NIC) 212 which connects the system 200 to a communications network 220 such as the Internet.

The system 200 also includes a number of standard software modules, including an operating system 224 such as Linux or Microsoft Windows. The system 200 may include structured query language (SQL) support 230 such as MySQL, available from http://www.mysql.com, which allows data to be stored in and retrieved from an SQL database 232, including output data generated by modules 202. The recommendation system 200 may also include web server software 233 such as Apache, available at http://www.apache.org, and scripting language support 234 such as PHP, available at http://www.php.net, or Microsoft ASP.

Together, the web server 233, scripting language 234, and SQL modules 230 provide the system 200 with the general ability to allow client computing devices 100 equipped with standard web browser software to access the system 200 and in particular to provide data to and receive data from the database 232.

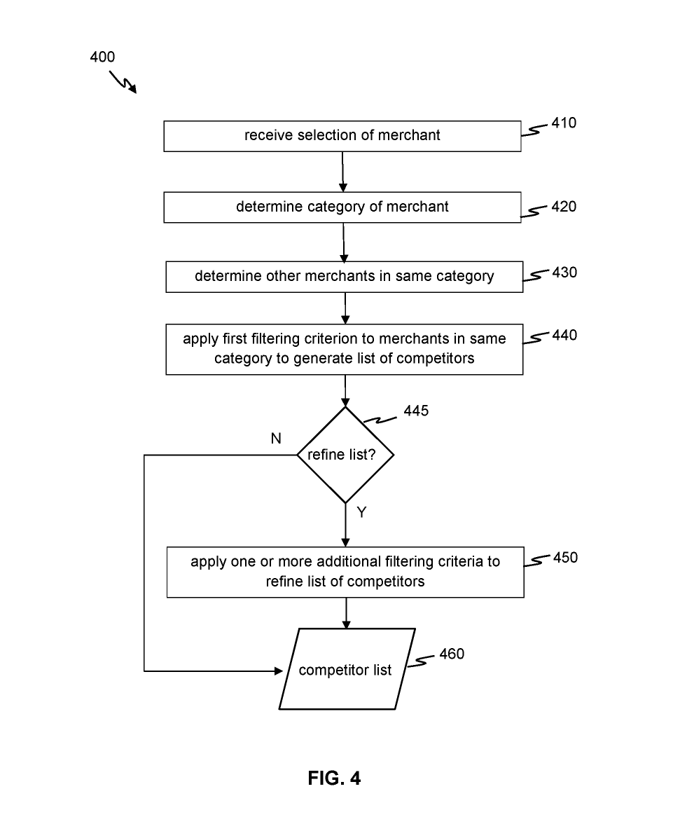

However, it will be understood by those skilled in the art that the specific functionality provided by the system 200 to such users may be provided by scripts accessible by the web server 233, including the software components 202 implementing the processes described below with reference to FIG. 4, and also any other scripts and supporting data, including markup language (e.g., HTML, XML) scripts, PHP (or ASP), and/or CGI scripts, image files, style sheets, and the like.

Turning now to FIG. 4, there is shown a flow chart of an exemplary competitor recommendation process 400.

At step 410, the competitor recommendation system 200 receives, via web server 233 from client device 100, a selection of a merchant for which potential competitor merchants are to be recommended. This may be by way of user input of a merchant name or other identifier into a user interface of a client application (e.g. a web browser) executing on user device 100. If the merchant is registered with the competitor recommendation system 200 then the merchant name or other identifier may be automatically retrieved (e.g., from database 232) when the merchant logs in to the system 200 via user device 100.

At step 420, the recommendation component 250 may determine, from the merchant selection, a category of the selected merchant. This may be determined by the recommendation component 250 querying the merchant database 150 to retrieve a merchant category code (MCC) of the merchant.

Next, at step 430, the recommendation component 250 queries the merchant database 150 to identify other merchants which are in the same category, e.g. which have the same MCC. For example, if the selected merchant has category “restaurant”, the recommendation component 250 searches for other merchants of category “restaurant” in the merchant database 150.

Once a list of merchants of the same category as the selected merchant has been identified, at step 440 the recommendation component 250 applies a first filtering criterion to the list of merchants to generate a list of competitor merchants. The first filtering criterion may be based on a merchant-related characteristic which is stored in the merchant database 150, such as geographical location, sub-category of merchant (e.g., “fast food restaurant” if the merchant category is “restaurant”), whether the merchant is a chain store or a boutique store, etc.

In one example, the filtering criterion may be chosen to restrict the potential competitors to those which are geographically nearby, such as being located in the same city or state, or within a certain radius of the selected merchant. In this example, the recommendation component 250 may retrieve, from merchant database 150, geolocation data for the selected merchant and for each merchant in the list of merchants of the same category as the selected merchant. The recommendation component 250 may then compute respective distances between the selected merchant and each other merchant, and filter out those merchants which are more than a threshold distance away from the selected merchant. Alternatively, the recommendation component 250 may match part of the geolocation data (such as the city or state in which the selected merchant is located) for the selected merchant and the other merchants in the same category and filter out the non-matching merchants.

In another example, the first filtering criterion may be a transaction data-based filtering criterion, for example based on transaction-related parameters such as average ticket size (ticket size for a transaction record being the total cleared value of the transaction), average customer spend, total number of transactions or total number of customers. In this example, transaction records for the selected merchant are retrieved, and at least one transaction-related parameter, such as average ticket size (within a predetermined period, such as the last year of transactions) is computed from the transaction records for the selected merchant. The same transaction-related parameter is then computed for each other merchant in the same category. Merchants for which the value of the transaction-related parameter differ by more than a threshold amount from the corresponding value for the selected merchant are then filtered out. The threshold may be an absolute threshold, for example a dollar value difference if average ticket size is used, or a percentage difference (e.g., 5%, 10%, 15%, 20%, or 25%).

To compute the transaction-related parameter, the recommendation component 250 queries the transactions database 236 (or the data warehouse database 132) to retrieve transaction records for the merchant and for the other merchants in the same category. The query is preferably limited to a time window, such as the previous year's worth of transactions, for example.

The choice of the first filtering criterion may be user-driven, for example via input received by the web server 233 from user device 100. The web server 233 may also receive input from user device 100 relating to one or more additional filtering criteria to be applied. The one or more additional filtering criteria may be based on merchant information or may be based on a transaction-related parameter, as discussed above. Accordingly, the first filtering criterion may be a geographical location-based criterion while a second filtering criterion is based on a transaction-related parameter, or vice versa. Alternatively, each filtering criterion may be based on a transaction-related parameter (e.g., average ticket size and total number of customers), for example.

If input is received from user device 100 indicating that more than one filtering criterion is to be applied, then at step 445, the recommendation component 250 applies the additional criterion or additional criteria at step 450 to refine the list of competitor merchants 460. Otherwise, the list of merchants remaining after the first filtering criterion is applied is returned as the list of competitor merchants 460.

The list 460, or part thereof, may be transmitted to the user device 100 by web server 233, for example, and displayed in a user interface of the user device 100. The list 460 may be ranked, for example in terms of “closeness” to the selected merchant for the chosen filtering criteria, or in terms of total spend for the respective merchants in the list. In some embodiments the top 5, top 10 or top 20 (for example) ranked competitors may be transmitted to the user device 100. The number of competitors to be recommended by the recommendation component 250 may be user-defined, by the user entering a preferred number in a user interface of the web browser executing on user device 100, for example.

In some embodiments, the names of the competitors are transmitted to the user device 100, but not the actual ranks or similarity scores.

In some embodiments, the list of competitors 460 may be used for downstream analyses, for example to compute overall market share of the selected merchant, or market share of the selected merchant within a particular market segment. The information on market share is useful to the merchant in determining market segments in which customers transact with the merchant's competitors 460, and therefore which market segments might be profitable for the merchant to target.

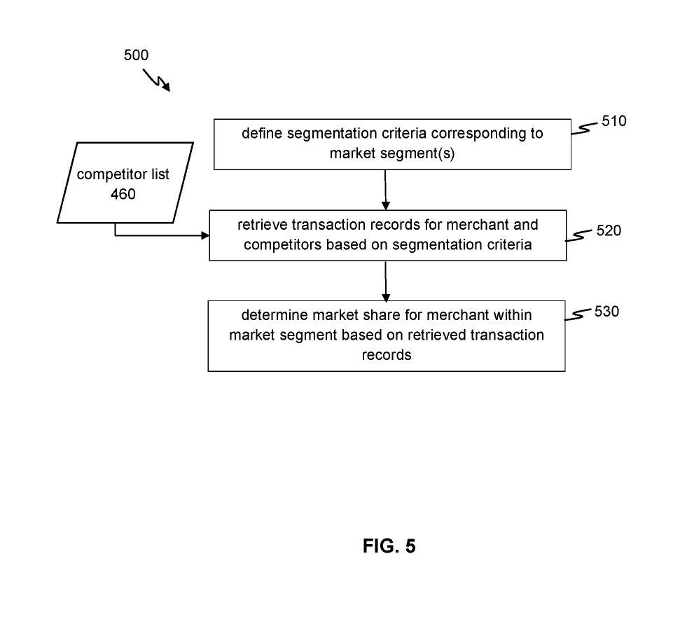

An example of a market segment analysis process 500 is shown in FIG. 5. At step 510, one or more segmentation criteria corresponding to respective market segments is or are defined by the segmentation component 252 (FIG. 3). The segmentation component 252 may receive input data relating to the one or more segmentation criteria from user device 100 via web server 233, for example. The one or more segmentation criteria may be based on demographic parameters such as geographical region (e.g., postcode, ZIP code, city, town, etc.), age, gender, marital status, number of dependents, and salary. For example, the user at user device 100 may specify that they wish to determine the market share for the selected merchant based on geographical region, age ranges (e.g. under 18, 19-25, 26-35 and 36 and above), or a combination of the two.

Once the segmentation criteria have been defined, the segmentation component 252 retrieves the transaction records for the selected merchant and the merchants in competitor list 460, and performs a clustering operation to group them according to the defined segmentation criteria, at step 520. For example, if one of the segmentation criteria is a geographical region criterion, such as ZIP code, the segmentation component 252 may determine, from the retrieved transaction records, a set of card identifiers, and query the data warehouse database 132 in order to determine the corresponding ZIP codes. The segmentation component 252 may then group the transaction records for each merchant by ZIP code. A similar operation can be carried out for other segmentation criteria. For example, if gender is one of the segmentation criteria then the transaction records can be grouped into “male” and “female” groups for further analysis. Further, combinations of segmentation criteria can be used to provide finer segmentation (e.g., transactions associated with males living in respective ZIP codes).

Following segmentation of the transaction records, the segmentation component 252 may compute, at step 530, one or more aggregate statistics for each segment for each merchant, such as a total value or total number of transactions in the segment. The one or more aggregate statistics may be used to determine a market share for the selected merchant in that segment, based on (for example) the total value of transactions for the selected merchant compared to the total value of transactions for all merchants (i.e., the selected merchant and the merchants in list 460).

As used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications may be made to this configuration without departing from the scope or spirit of the claimed subject matter.

1. A system for recommending a competitor to a merchant, the system comprising:
a transactions database storing transaction data relating to a plurality of transactions made at a plurality of merchants over a payment network using a plurality of payment cards;
a merchant database storing merchant data relating to the plurality of merchants; and
a competitor identification component in communication with the transactions database;
wherein the competitor identification component is configured to:
determine a category of the merchant;
query the merchant database to identify other merchants having the same category as the merchant;
query the transactions database to retrieve transaction data relating to transactions made at the merchant and the other merchants over a predefined time period;
based on one or more filtering criteria, determine similarity data indicative of a similarity of each of the other merchants to said merchant; and based on the similarity data, generate a recommendation of at least one competitor merchant from among the other merchants.

2. A system according to claim 1, wherein at least one of the filtering criteria relates to a merchant characteristic.

3. A system according to claim 2, wherein the merchant characteristic is selected from the group consisting of geographical location and merchant sub-category.

4. A system according to claim 3, wherein the merchant characteristic is geographical location, and wherein the similarity data are indicative of respective distances between a geographical location of the merchant and respective geographical locations of the other merchants.

5. A system according to claim 1, wherein at least one of the filtering criteria is a transaction data-based filtering criterion; and wherein the similarity data is determined by computing a distance between a value of a transaction-related parameter for the merchant and respective values of the transaction-related parameter for each of the other merchants.

6. A system according to claim 1, wherein the category of the merchant is determined according to a Merchant Category Code (MCC) of the merchant.

7. A system according to claim 5, wherein the transaction-related parameter is one or more of: average transaction size; number of transactions per year; and average spend per payment card.

8. A system according to claim 1, further comprising a segmentation component which is configured to:
generate one or more segmentation criteria corresponding to respective market segments;
perform a clustering operation on the transaction data based on the segmentation criteria to group the transactions into respective segments for the merchant and for respective competitor merchants; and
for each segment, generate market share data for the merchant based on an aggregate value or total number of transactions compared to an aggregate value or total number of transactions for the competitor merchants.

9. A method for recommending a competitor to a merchant, the method comprising:
storing, in a transactions database, transaction data relating to a plurality of transactions made at a plurality of merchants over a payment network using a plurality of payment cards;
storing, in a merchant database, merchant data relating to the plurality of merchants;
providing a competitor identification component in communication with the transactions database;
determining, by the competitor identification component, a category of the merchant;
querying, by the competitor identification component, the merchant database to identify other merchants having the same category as the merchant;
querying, by the competitor identification component, the transactions database to retrieve transaction data relating to transactions made at the merchant and the other merchants over a predefined time period;
determining, by the competitor identification component based on one or more filtering criteria, similarity data indicative of a similarity of each of the other merchants to said merchant; and
generating, by the competitor identification component based on the similarity data, a recommendation of at least one competitor merchant from among the other merchants.

10. A method according to claim 9, wherein at least one of the filtering criteria relates to a merchant characteristic.

11. A method according to claim 10, wherein the merchant characteristic is selected from the group consisting of geographical location and merchant sub-category.

12. A method according to claim 11, wherein the merchant characteristic is geographical location, and wherein the similarity data are indicative of respective distances between a geographical location of the merchant and respective geographical locations of the other merchants.

13. A method according to claim 9, wherein at least one of the filtering criteria is a transaction data-based filtering criterion; and wherein the similarity data is determined by computing a distance between a value of a transaction-related parameter for the merchant and respective values of the transaction-related parameter for each of the other merchants.

14. A method according to claim 9, wherein the category of the merchant is determined according to a Merchant Category Code (MCC) of the merchant.

15. A method according to claim 14, wherein the transaction-related parameter is one or more of: average transaction size; number of transactions per year; and average spend per payment card.

16. A method according to claim 9, further comprising:
generating, using a segmentation component, one or more segmentation criteria corresponding to respective market segments;
performing, by the segmentation component, a clustering operation on the transaction data based on the segmentation criteria to group the transactions into respective segments for the merchant and for respective competitor merchants; and
for each segment, generating, by the segmentation component, market share data for the merchant based on an aggregate value or total number of transactions compared to an aggregate value or total number of transactions for the competitor merchants.

17. A non-transitory computer-readable medium for recommending a competitor to a merchant, the non-transitory computer-readable medium having stored thereon program instructions for causing at least one processor to:
store, in a transactions database, transaction data relating to a plurality of transactions made at a plurality of merchants over a payment network using a plurality of payment cards;
store, in a merchant database, merchant data relating to the plurality of merchants;
determine a category of the merchant;
query the merchant database to identify other merchants having the same category as the merchant;
query the transactions database to retrieve transaction data relating to transactions made at the merchant and the other merchants over a predefined time period;
determine, based on one or more filtering criteria, similarity data indicative of a similarity of each of the other merchants to said merchant; and
generate, based on the similarity data, a recommendation of at least one competitor merchant from among the other merchants.

18. A non-transitory computer-readable medium according to claim 17, wherein at least one of the filtering criteria relates to a merchant characteristic.

19. A non-transitory computer-readable medium according to claim 18, wherein the merchant characteristic is selected from the group consisting of geographical location and merchant sub-category.

20. A non-transitory computer-readable medium according to claim 19, wherein the merchant characteristic is geographical location, and wherein the similarity data are indicative of respective distances between a geographical location of the merchant and respective geographical locations of the other merchants.

21. A non-transitory computer-readable medium according to claim 17, wherein at least one of the filtering criteria is a transaction data-based filtering criterion; and wherein the similarity data is determined by computing a distance between a value of a transaction-related parameter for the merchant and respective values of the transaction-related parameter for each of the other merchants.

22. A non-transitory computer-readable medium according to claim 17, wherein the category of the merchant is determined according to a Merchant Category Code (MCC) of the merchant.

23. A non-transitory computer-readable medium according to claim 22, wherein the transaction-related parameter is one or more of: average transaction size; number of transactions per year; and average spend per payment card.

24. A non-transitory computer-readable medium according to claim 17, wherein the program instructions further comprise instructions for causing at least one processor to:
generate one or more segmentation criteria corresponding to respective market segments;
perform a clustering operation on the transaction data based on the segmentation criteria to group the transactions into respective segments for the merchant and for respective competitor merchants; and
for each segment, generate market share data for the merchant based on an aggregate value or total number of transactions compared to an aggregate value or total number of transactions for the competitor merchants.
